(19) United States
(12) Patent Application Publication
(10) Pub. No.: US 2007/0028582 A1
(43) Pub. Date: Feb. 8, 2007

(54) Manual spiral grader

(76) Inventor: Francois Giguere, St-Joseph-de-Lac (CA)

Correspondence Address: Francois Giguere, 1291, Rang du Domaine, St-Joseph-du Lac, JON 1MO, CA

(21) Appl. No.: 11/349,097

(22) Filed: Feb. 8, 2006

(30) Foreign Application Priority Data
Feb. 17, 2005 (CA) 2,494,778

(51) Int. Cl. A01D 7/00

(52) U.S. Cl. 56/400.01; 172/371

(57) ABSTRACT

A hand-held manual tool used to even out or level the ground, similar to a rake. A rake, even handled with care, leaves tracks on the ground such as grooves, undulations, edges, etc. This contraption is a manual and light spiral formed tool, which allows leveling and even the ground in an easy movement. Even if the movements are done in any directions, it keeps the desired level for a smooth finish, without leaving any tracks on the ground.

### BRIEF SUMMARY OF THE INVENTION

This present invention, called manual spiral grader, belongs to a hand-held manual usage tool to even or level the ground, such as earth surface, small gravel, rock dust, sand or any other unalike granule matter.

There are already large grading machines to level landspaces, but these machines are inefficient and inadequate for small surfaces. A tool, such a rake, can be used, but the end results to the ground will be rippled. The edges will be more or less pronounced because the rake allows dirt to pass unevenly, furthermore it limits the back and forth movement to front to back. The rake does not allow complete satisfaction when it is required to have a perfectly leveled surface.

It is possible to eliminate all these inconveniences while increasing execution speed by using the manual spiral grader. It can be handled in all directions, meaning as much as left to right, front to back and vice versa or in a rotating movement. What's more, while movements do not necessitate any special attention, you will obtain better results. This manual spiral grader is a new and perfect invention in the domain of small tools to even out or level the ground for preparation work or for landscaping finished surfaces. For example, not only can it be used to prepare the ground to receive seeding, but can also be used to cover them while leaving a leveled surface, a smooth and impeccable finish, exempt of waves, edges or grooves.

### INVENTION SUMMARY

A manual hand-held device, used to level various surfaces such as dirt, sand, small gravel, rock dust or any unalike granule matter, has a spiral-shaped part, a mounting unit and a handle.

The spiral-shaped part, which comes into contact with the ground, is a round rod which may be made out of either steel, aluminum, nylon or plastic. This round rod is turned toward itself three and a half times to form the first section, a spiral, and continues in the second section to form a straight-lined shape. This second section, a straight-line, continues on top and across the first section. It will be used to connect the mounting unit when the device is manufactured.

The mounting unit, preferably in the shape of an arc, is made out of steel, aluminum, nylon or plastic. Each end of the mounting unit has to have a slotted perforation and another hole is required in the center at equal distance between the two slotted end perforations.

This mounting unit is inserted by its two slotted ends in the second straight-lined section of the spiral-shaped part. The straight-lined section will be welded at every contact point with the spiral-shaped section, which will total seven welding points to connect these two sections together to become the spiral-shaped part.

The mounting unit is now restrained in the spiral-shaped part. The mounting unit can rotate up to 90 degrees on either side of the spiral-shaped part. The mounting unit is now connected to the spiral-shaped part and is joined by the hole located in the center which is at equal distance of both holes to one of the extremities of the handle by a screw and a nut.

To summarize, while holding this manual hand-held tool by the handle connected to the mounting unit which is joined to the spiral-shaped part, we now have a manual usage tool: the manual spiral grader.

### BRIEF DESCRIPTION OF THE DRAWING

In reference to the drawings which illustrate the making of the invention:

FIG. 1: represents a perspective of the manual spiral grader.

FIG. 2: represents a plan view of the spiral-shaped part.

FIG. 3: represents a front view of the mounting unit which will be restrained in the spiral-shaped part, once the device is manufactured.

FIG. 4: represents the handle, screw and nut.

### DETAILED DESCRIPTION OF THE DRAWINGS

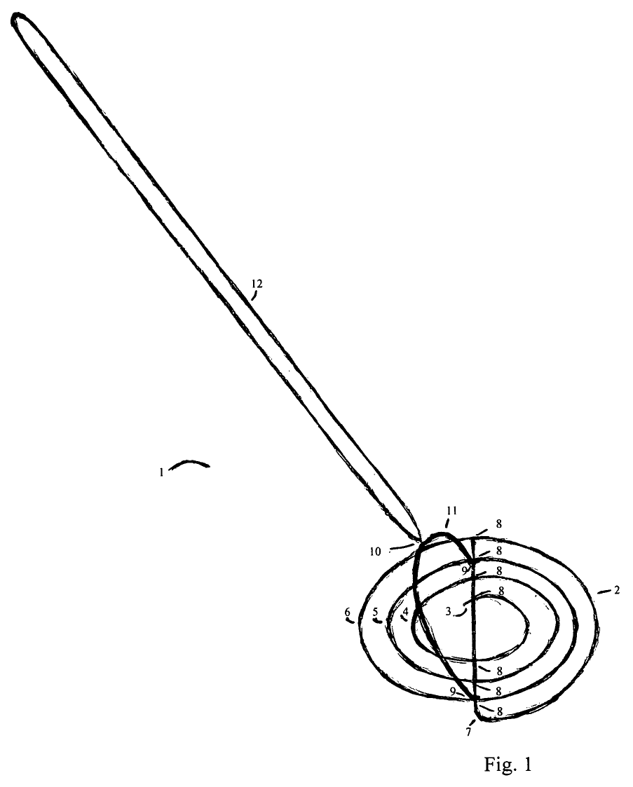

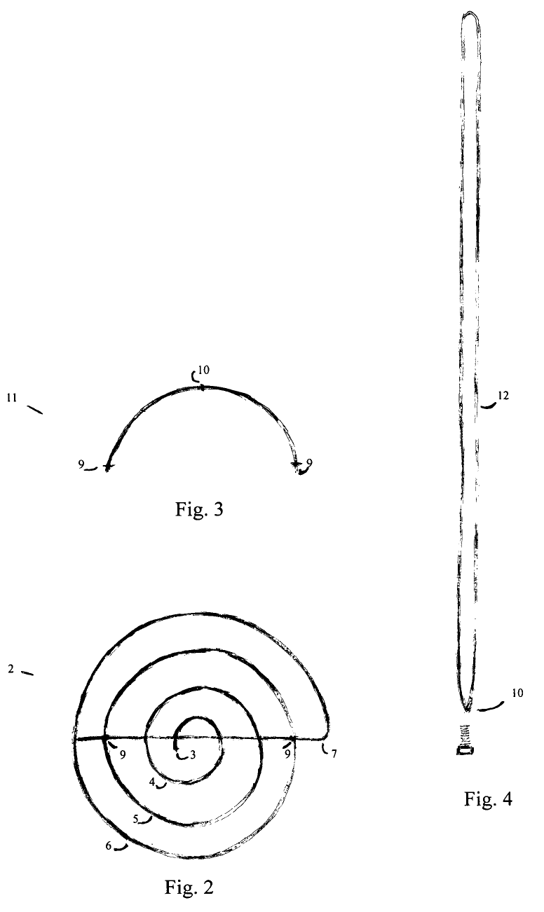

FIG. 1 shows the manual spiral grader 1 including the spiral-shaped part 2 as shown on FIG. 2. This spiral-shaped part is built from a first section 3, a ¼ inch round steel rod which is turned towards itself three and a half times 4, 5 and 6 to form a spiral and then continues along to a second section 7 in a straight-lined shape on top and across the first spiral-shaped section.

FIG. 1, the manual spiral grader 1 also includes a mounting unit 11 as shown on FIG. 3. This mounting unit 11 consists of a flat steel arc of ¾ inch by ⅛ inch. This flat steel arc has holes at both ends 9, and a third hole 10 located in the center at equals distance between the first and the second slotted holes at the extremities 9.

FIG. 1, the manual spiral grader 1 includes also a wooden handle 12 as shown on FIG. 4.

The mounting unit 11 is joined to the spiral-shaped part 2 (FIG. 1). The mounting unit is inserted through the two holes at the opposite ends 9 in the second straight-lined section 7 at the points 9 of spiral-shaped part 2.

Then seven welds 8 will be done at each contact points on the straight-lined section 7 and the spiral-shaped section 3 to attach the three rings and a half 4, 5 and 6 permanently. In another words, the spiral-shaped section is connected to straight-lined section 7 of the spiral-shaped part 2 (FIG. 1). The spiral-shaped part 2 restrains the mounting unit 11 (FIG. 1). The mounting unit is attached through the center hole 10 to one of the extremities 10 of the wooden handle 12 with a screw and a nut (FIG. 1).

While holding this tool by the handle 12 (FIG. 1), which is attached to the mounting unit 11 which in its turn is joined to the spiral-shaped part 2, this device can be move on the ground in a variety of movements. These movements can be from front to back and can be executed in all directions with the goal of obtaining a perfectly leveled ground. Furthermore, for a better understanding of the tool, you will find, following the drawings, three pictures of the manual spiral grader.

### EXAMPLES OF APPLICATION

a) Landscaping work: prepares the ground to receive seeding, grass, sod, paving stones.
b) Sand traps at golf courses, playgrounds and parks: levels sand traps and removes tracks, footprints, or ball imprints.

This hand-held manual spiral grading tool is made out of steel and is provided with a wooden handle. Nevertheless, it also can be made out of aluminum, nylon or plastic and the handle can be in fiberglass depending on the needs of the work to be executed. Various alternate designs of the invention can bring different benefits provided that one respects the techniques of craftsmanship stated in the original design of this invention.

The design of the invention of which ones exclusive right of property or privilege is claimed are defined as follows:

1. A manual hand-held usage device used to level ground surface, sand, small gravel, rock dust or any other unalike granule matter, including a handle, with two extremities. One of the extremities is attached to a mounting unit which is joined to the spiral-shaped part.

2. A device, according to claim number 1, characterized by the spiral-shaped part which consists of a first section in the shape of a round steel rod turned towards itself on three and a half rotations forming a spiral.

3. A device, according to claim number 2, characterized by the spiral-shaped part which consists of a second straight-line shaped section on top and across the first spiral-shaped section.

4. A device, according to claim number 1, characterized by the mounting unit which comprises a steel arc with holes at both extremities and a third hole located in the center at equal's distance of the two perforated extremities.

5. A device, according to claim number 3, characterized by the mounting unit which is inserted in the straight-lined section of the spiral-shaped part when the device is manufactured.

6. A device, according to both claims 3 and 5, characterized by the weldings which are present on seven different contact points on the second straight-line shaped section and the first spiral-shaped section connecting both the second straight-lined section and the first spiral-shaped section and restraining the mounting unit in the spiral-shaped part.

7. A device, according to claim number 1, characterized by the handle made out of wood.

8. A device, according to claim number 4, characterized by one of the extremities of the wooden handle connected by a screw and a nut to the third center hole of the mounting unit.

9. A device, according to claims number 1 through 8, characterized by the spiral-shaped part and the mounting unit which are made out of materials chosen from these groups: steel, aluminum, nylon and plastic.

10. A device, according to claim number 1, characterized by the handle being made out of fiberglass.
